(19) United States
(12) Patent Application Publication
(10) Pub. No.: US 2018/0194241 A1
(43) Pub. Date: Jul. 12, 2018

(54) CHARGING AUTHORIZATION APPROACH FOR OBJECTS TO BE RECHARGED AND AUTOMATIC AUTHORIZATION APPROACH AND SYSTEM FOR CHARGING APPARATUSES

(71) Applicant: NIO CO., LTD., SHANGHAI (CN)

(72) Inventors: Tianlei HAO, Shanghai (CN); Fei SHEN, Shanghai (CN); Jie SHAO, Shanghai (CN); Jianxing ZHANG, Shanghai (CN); Xiaobin PAN, Shanghai (CN); Yicheng WU, Shanghai (CN); Hui XING, Shanghai (CN); Huan TONG, Shanghai (CN); Ruotong JIANG, Shanghai (CN); Litao FU, Shanghai (CN); Tianshu LI, Shanghai (CN); Yuhua LV, Shanghai (CN)

(21) Appl. No.: 15/866,053

(22) Filed: Jan. 9, 2018

(30) Foreign Application Priority Data
Jan. 9, 2017 (CN) 201710013520.X

(51) Int. Cl. B60L 11/18; G06F 21/31; H02J 7/00

(52) U.S. Cl. CPC B60L 11/1846; G06F 21/31; B60L 2270/30; B60L 2250/20; H02J 7/0027

(57) ABSTRACT

The present application relates to the field of charging electrical apparatuses, and more particularly, to a charging authorization approach for objects to be recharged, an automatic authorization approach and system for charging apparatuses. The present application intends to solve the problem of complicate authentication procedure and poor user experience when a charging apparatus authenticates an electric vehicle in the prior art. The automatic authorization approach for charging apparatuses of the application comprises the following steps: plugging a charging gun of said charging apparatus into a charging port of an object to be recharged and hence activating a first authentication device; said first authentication device sending an authentication request information; a second authentication device receiving said authentication request information and matching it to a prestored valid authentication information; determining whether said charging apparatus should charge said object to be recharged based on the matching result. With the approach of the application, it only requires a user to plug the charging gun into the charging port of the electric vehicle, in order for the charging apparatus to automatically authenticate the electric vehicle, which makes the authentication procedure simpler, and no other authentication operations are required from the user, so that the charging experience of an electric vehicle user is considerably improved.

### CROSS-REFERENCE TO RELATED APPLICATIONS

This application claims the benefit of China Patent Application No. 201710013520.X filed Jan. 9, 2017, the contents of which are incorporated herein by reference.

### TECHNICAL FIELD

The present application relates to the field of charging electrical apparatuses, and more particularly, to an automatic authorization approach and system for charging apparatuses.

### BACKGROUND

At present, there are mainly two ways of energy replenishment for electric vehicles: one is battery swapping (swapping a power battery) and the other is direct charging with a charging apparatus. However, both ways of energy replenishment require authentication for electric vehicles, and battery swapping and charging may only be performed for the authenticated electric vehicles.

Following are the main methods for authenticating electric vehicles to a charging apparatus: authenticating with a physical lock and a physical key, authenticating with a mobile APP, authenticating with a RFID card, authenticating with fingerprint recognition, authenticating with iris recognition, etc. However, the authentication procedures of the above authentication methods are relatively complicated, time consuming, and the electric vehicles are not able to be charged in time especially when a user forgets to bring the key, cell phone, or RFID card used for authentication.

Accordingly, there is a need in the art for a new authentication approach for charging apparatuses to address the above problems.

### SUMMARY

In order to address the above problems in the prior art, i.e. in order to solve the problem of complicate authentication procedure and poor user experience when a charging apparatus authenticates an electric vehicle in the prior art, the present application provides an automatic authorization approach for charging apparatuses, which comprises the following steps: plugging a charging gun of said charging apparatus into a charging port of an object to be recharged and hence activating a first authentication device; said first authentication device sending an authentication request information; a second authentication device receiving said authentication request information and matching it to a prestored valid authentication information; determining whether said charging apparatus should charge said object to be recharged or not based on the matching result.

In a preferred technical solution of the above automatic authorization approach for charging apparatuses, the step of said “activating a first authentication device” further comprises: activating said first authentication device, when a detection device disposed on said object to be recharged detects that a charging gun of said charging apparatus is plugged into a charging port of said object to be recharged.

In a preferred technical solution of the above automatic authorization approach for charging apparatuses, said first authentication device is disposed on said object to be recharged, or is used together with said object to be recharged.

In a preferred technical solution of the above automatic authorization approach for charging apparatuses, the step of “said first authentication device sending an authentication request information” further comprises: said first authentication device sending said authentication request information by way of wireless communication or wired communication.

In a preferred technical solution of the above automatic authorization approach for charging apparatuses, said wireless communication comprises WIFI, Bluetooth, or ZIGBEE.

In a preferred technical solution of the above automatic authorization approach for charging apparatuses, said wired communication comprises power line carrier communication.

In a preferred technical solution of the above automatic authorization approach for charging apparatuses, said second authentication device is disposed on said charging apparatus or on a remote terminal.

In a preferred technical solution of the above automatic authorization approach for charging apparatuses, the step of said “determining whether said charging apparatus should charge said object to be recharged or not based on the matching result” further comprises: enable said charging apparatus to charge said object to be recharged, when said authentication request information is matched with a prestored valid authentication information; do not allow said charging apparatus to charge said object to be recharged, when said authentication request information is not matched with a prestored valid authentication information.

In a preferred technical solution of the above automatic authorization approach for charging apparatuses, said charging apparatus is a direct current charging post, a direct current charger, an alternating current charging post, or an alternating current charger.

In a preferred technical solution of the above automatic authorization approach for charging apparatuses, said object to be recharged is an electrical apparatus.

In a preferred technical solution of the above automatic authorization approach for charging apparatuses, said electrical apparatus is an electric vehicle, or an electric motorcycle, or an electric bicycle.

In a preferred technical solution of the above automatic authorization approach for charging apparatuses, said detection device is a voltage detection circuit.

In another aspect, the present application provides an automatic authorization system for charging apparatuses, which comprises: a first authentication device, which is activated when a charging gun of said charging apparatus is plugged into a charging port of an object to be recharged, and sends an authentication request information; a second authentication device, which receives said authentication request information and matches it to a prestored valid authentication information; wherein said automatic authorization system for charging apparatuses is also capable of determining whether said charging apparatus should charge said object to be recharged or not based on the matching result above.

In a preferred technical solution of the above automatic authorization system for charging apparatuses, said automatic authorization system for charging apparatuses further comprises a detection device, which is disposed on said object to be recharged, for detecting whether a charging gun of said charging apparatus is plugged into a charging port of said object to be recharged.

In a preferred technical solution of the above automatic authorization system for charging apparatuses, said first authentication device is disposed on said object to be recharged, or is used together with said object to be recharged.

In a preferred technical solution of the above automatic authorization system for charging apparatuses, said first authentication device sends said authentication request information by way of wireless communication or wired communication.

In a preferred technical solution of the above automatic authorization system for charging apparatuses, said wireless communication comprises WIFI, Bluetooth, or ZIGBEE.

In a preferred technical solution of the above automatic authorization system for charging apparatuses, said wired communication comprises power line carrier communication.

In a preferred technical solution of the above automatic authorization system for charging apparatuses, said second authentication device is disposed on said charging apparatus or on a remote terminal.

In a preferred technical solution of the above automatic authorization system for charging apparatuses, said automatic authorization system for charging apparatuses enables said charging apparatus to charge said object to be recharged, when said authentication request information is matched with the valid authentication information; moreover, said automatic authorization system for charging apparatuses does not allow said charging apparatus to charge said object to be recharged, when said authentication request information is not matched with the valid authentication information.

In a preferred technical solution of the above automatic authorization system for charging apparatuses, said charging apparatus is a direct current charging post, a direct current charger, an alternating current charging post, or an alternating current charger.

In a preferred technical solution of the above automatic authorization system for charging apparatuses, said object to be recharged is an electrical apparatus.

In a preferred technical solution of the above automatic authorization system for charging apparatuses, said electrical apparatus is an electric vehicle, or an electric motorcycle, or an electric bicycle.

In a preferred technical solution of the above automatic authorization system for charging apparatuses, said detection device is a voltage detection circuit.

In yet another aspect of the application, an automatic authorization approach for charging apparatuses is provided. Said approach is characterized in that it comprises the following steps: receiving an authentication request information and matching said authentication request information to a prestored valid authentication information, when a charging gun of said charging apparatus is plugged into a charging port, or when said charging gun is pulled out of said charging apparatus; determining whether said charging apparatus should provide a charging service or not based on the matching result.

In a preferred embodiment of the above automatic authorization approach for charging apparatuses, the step of “receiving said authentication request information” further comprises: receiving said authentication request information via an authentication device by way of wireless communication or wired communication.

In a preferred embodiment of the above automatic authorization approach for charging apparatuses, said wireless communication comprises WIFI, Bluetooth, or ZIGBEE.

In a preferred embodiment of the above automatic authorization approach for charging apparatuses, said wired communication comprises power line carrier communication.

In a preferred embodiment of the above automatic authorization approach for charging apparatuses, said authentication device is disposed on said charging apparatus or on a remote terminal.

In a preferred embodiment of the above automatic authorization approach for charging apparatuses, the step of said “determining whether said charging apparatus should provide a charging service or not based on the matching result” further comprises: said charging apparatus is enabled to provide a charging service, when said authentication request information is matched with a prestored valid authentication information; said charging apparatus is not allowed to provide a charging service, when said authentication request is not matched with a prestored valid authentication information.

In a preferred embodiment of the above automatic authorization approach for charging apparatuses, said charging apparatus is a direct current charging post, a direct current charger, an alternating current charging post, or an alternating current charger.

In yet another aspect of the application, a charging authorization approach for objects to be recharged is provided. Said approach is characterized in that it comprises the following steps: detecting an action of requiring charging for an object to be recharged; the object to be recharged sends an authentication request information; said object to be recharged accepts charging in the case that an authentication is granted.

In a preferred embodiment of the above charging authorization approach for objects to be recharged, said “detecting an action of requiring charging for an object to be recharged is detected” further comprises: a charging gun being plugged into a charging port of said object to be recharged is detected by a detection device disposed on said object to be recharged.

It should be understood by those skilled in the art that although “an action of requiring charging for the object to be recharged” is described herein as a charging gun being plugged into a charging port of the object to be recharged, the present application is apparently not to be limited hereby, and it is obvious that said action may also be any other actions that may indicate the charging intention of a user, for example, a charging gun is pulled out of a charging apparatus, a cap of the charging port is popped open, etc.

In a preferred embodiment of the above charging authorization approach for objects to be recharged, the step of said “the object to be recharged sends an authentication request information” further comprises: activating an authentication device, sending said authentication request information with said authentication device.

In a preferred embodiment of the above charging authorization approach for objects to be recharged, said authentication device is disposed on said object to be recharged, or is used together with said object to be recharged.

In a preferred embodiment of the above charging authorization approach for objects to be recharged, the step of “sending said authentication request information with said authentication device” further comprises: said authentication device sends said authentication request information by way of wireless communication or wired communication.

In a preferred embodiment of the above charging authorization approach for objects to be recharged, said wireless communication comprises WIFI, Bluetooth, or ZIGBEE.

In a preferred embodiment of the above charging authorization approach for objects to be recharged, said wired communication comprises power line carrier communication.

In a preferred embodiment of the above charging authorization approach for objects to be recharged, said object to be recharged is an electrical apparatus.

In a preferred embodiment of the above charging authorization approach for objects to be recharged, said electrical apparatus is an electric vehicle, or an electric motorcycle, or an electric bicycle.

In a preferred embodiment of the above charging authorization approach for objects to be recharged, said detection device is a voltage detection circuit.

In yet another aspect of the application, an automatic authorization approach for charging apparatus is provided, which comprises the following steps: pulling a charging gun out of said charging apparatuses and hence activating a first authenticating device; said first authentication device sending an authentication request information; a second authentication device receiving said authentication request information and matching it to a prestored valid authentication information; determining whether said charging apparatus should charge said object to be recharged or not based on the matching result.

In a preferred embodiment of the above automatic authorization approach for charging apparatuses, the step of said “activating a first authentication device” further comprises: activating said second authentication device when a detection device disposed on said charging apparatus detects that said charging gun is pulled out of said charging apparatus; said second authentication device activating said first authentication device.

In a preferred embodiment of the above automatic authorization approach for charging apparatuses, said first authentication device is disposed on said object to be recharged, or is used together with said object to be recharged.

In a preferred embodiment of the above automatic authorization approach for charging apparatuses, the step of “said first authentication device sending an authentication request information” further comprises: said first authentication device sending said authentication request information by way of wireless communication or wired communication.

In a preferred embodiment of the above automatic authorization approach for charging apparatuses, said wireless communication comprises WIFI, Bluetooth, or ZIGBEE.

In a preferred embodiment of the above automatic authorization approach for charging apparatuses, said wired communication comprises power line carrier communication.

In a preferred embodiment of the above automatic authorization approach for charging apparatuses, said second authentication device is disposed on said charging apparatus or on a remote terminal.

In a preferred embodiment of the above automatic authorization approach for charging apparatuses, the step of said “determining whether said charging apparatus should charge said object to be recharged or not based on the matching result” further comprises: said charging apparatus is enabled to charge said object to be recharged, when said authentication request information is matched with a prestored valid authentication information; said charging apparatus is not allowed to charge said object to be recharged, when said authentication request information is not matched with a prestored valid authentication information.

In a preferred embodiment of the above automatic authorization approach for charging apparatuses, said charging apparatus is a direct current charging post, a direct current charger, an alternating current charging post, or an alternating current charger.

In a preferred embodiment of the above automatic authorization approach for charging apparatuses, said object to be charged is an electrical apparatus.

In a preferred embodiment of the above automatic authorization approach for charging apparatuses, said electrical apparatus is an electric vehicle, or an electric motorcycle, or an electric bicycle.

In a preferred embodiment of the above automatic authorization approach for charging apparatuses, said detection device is a voltage detection circuit.

In yet another aspect of the application, an automatic authorization system for charging apparatuses is provided, which comprises: a first authentication device, which is activated when a charging gun is pulled out of said charging apparatus and sends an authentication request information; a second authentication device, which receives said authentication request information and matches it to a prestored valid authentication information; wherein said automatic authorization system for charging apparatuses is also capable of determining whether said charging apparatus should charge said object to be recharged based on the above matching result.

In a preferred embodiment of the above automatic authorization system for charging apparatuses, said automatic authorization system for charging apparatuses further comprises a detection device, which is disposed on said charging apparatus, for detecting whether said charging gun is pulled out of said charging apparatus.

In a preferred embodiment of the above automatic authorization system for charging apparatuses, said first authentication device is disposed on said object to be recharged, or is used together with said object to be recharged.

In a preferred embodiment of the above automatic authorization system for charging apparatuses, said first authentication device sends said authentication request information by way of wireless communication or wired communication.

In a preferred embodiment of the above automatic authorization system for charging apparatuses, said wireless communication comprises WIFI, Bluetooth, or ZIGBEE.

In a preferred embodiment of the above automatic authorization system for charging apparatuses, said wired communication comprises power line carrier communication.

In a preferred embodiment of the above automatic authorization system for charging apparatuses, said second authentication device is disposed on said charging apparatus or on a remote terminal.

In a preferred embodiment of the above automatic authorization system for charging apparatuses, said automatic authorization system for charging apparatuses enables said charging apparatus to charge said object to be recharged, when said authentication request information is matched with a prestored valid authentication information; moreover, said automatic authorization system for charging apparatuses does not allow said charging apparatus to charge said object to be recharged, when said authentication request information is not matched with a prestored valid authentication information.

In a preferred embodiment of the above automatic authorization system for charging apparatuses, said charging apparatus is a direct current charging post, a direct current charger, an alternating current charging post, or an alternating current charger.

In a preferred embodiment of the above automatic authorization system for charging apparatuses, said object to be recharged is an electrical apparatus.

In a preferred embodiment of the above automatic authorization system for charging apparatuses, said electrical apparatus is an electric vehicle, an electric motorcycle, or an electric bicycle.

In a preferred embodiment of the above automatic authorization system for charging apparatuses, said detection device is a voltage detection circuit.

In a preferred embodiment of the application, a first authentication device disposed on an electric vehicle and a second authentication device disposed on a charging apparatus communicates authentication information by way of wired communication or wireless communication such as WIFI, Bluetooth, or ZIGBEE, etc., so as to realize an automatic authorization of the electric vehicle by the charging apparatus. With the automatic authorization approach for charging apparatuses of the application, it only requires a user to plug the charging gun into the charging port of the electric vehicle, in order for the charging apparatus to automatically authenticate the electric vehicle, which makes the authentication procedure simpler, and no other authentication operations are required from the user, nor is an extra authentication certificate required to be carried with the user, so that the charging experience of an electric vehicle user is considerably improved.

### BRIEF DESCRIPTION OF DRAWINGS

FIG. 1 is a flowchart of the main steps of the automatic authorization approach for charging apparatuses of the present application.

### DETAILED DESCRIPTION

The preferred embodiments of the application are described in reference with the accompanying drawings below. It should be understood by those skilled in the art that these embodiments are merely used for explaining the technical principles of the application, rather than intending to limit the scope of protection of the application. For example, although the specification sets electric vehicles and charging posts as examples to elaborate the automatic authorization approach of the application, it is obvious that the automatic authorization approach of the application may also apply to other electrical apparatuses such as electric bicycles, etc., and other charging apparatuses such as chargers, etc., and adjustment may be made thereto by those skilled in the art as desired, so as to adapt to particular application scenarios.

The automatic authorization system for charging apparatuses of the application mainly comprises: a first authentication device, a second authentication device and a detection device. Wherein, the first authentication device is used for sending an authentication request information to the second authentication device, said first authentication device is disposed on an object to be recharged, or those skilled in the art may dispose the first authentication device separately as desired, so that it may be used together with the object to be recharged. For example, when the object to be recharged is an electric vehicle, the first authentication device may be disposed in a smart key of an electric vehicle. Certainly, the first authentication may also be any other appropriate mobile terminals, or be disposed in any other appropriate mobile terminals, the physical form of which should not place any limitation on the scope of protection of the application. The second authentication device is used for receiving the authentication request information sent by the first authentication device, said second authentication device is disposed on a charging apparatus, or those skilled in the art may also dispose the second authentication device on other remote terminals as desired, for example, for public charging posts, the second authentication device may be disposed in a backend server or a cloud server which is used for collectively managing said public charging posts. The detection device is disposed on the object to be recharged, which is used for detecting whether a charging gun on the charging apparatus is plugged into a charging port of the object to be recharged, and when the detection device detects that the charging gun is plugged into the charging port, the system of the application activates the first authentication device. Preferably, the detection device is a voltage detection circuit disposed on an electric vehicle, which may send a voltage signal indicating this plugging status to the VCU of the electric vehicle when the charging gun is plugged into the charging port.

Further, the charging apparatus may be any apparatus that may provide electric energy, for example, a direct current charging post, a direct current charger, an alternating current charging post, and an alternating current charger, etc. The object to be recharged may be any electrical apparatus that requires for recharging, for example, an electric vehicle, an electric motorcycle, an electric bicycle, a cell phone, etc.

Even further still, the communication between the first authentication device and the second authentication device may be implemented in a wired way or in a wireless way, wherein, the way of wireless communication may be WIFI, Bluetooth, or ZIGBEE; the way of wired communication may be a way of power line carrier communication, or may be a way of direct communication with data cable, i.e. disposing a first communication terminal and a second communication terminal that may be matched to connect to each other on a charging port and a charging gun respectively, and further, connecting the first communication terminal to the first authentication device with data cable, connecting the second communication terminal to the second authentication device with data cable.

It may also be understood by those skilled in the art that under the circumstances where it is guaranteed that the charging apparatus is able to authenticate the object to be recharged, the first authentication device may be any form of signal generator, such as a Bluetooth signal transmitter, a WIFI signal generating module, etc.; the second authentication device may also be any form of signal receiver, such as a Bluetooth signal receiver, a WIFI signal receiving module, etc.

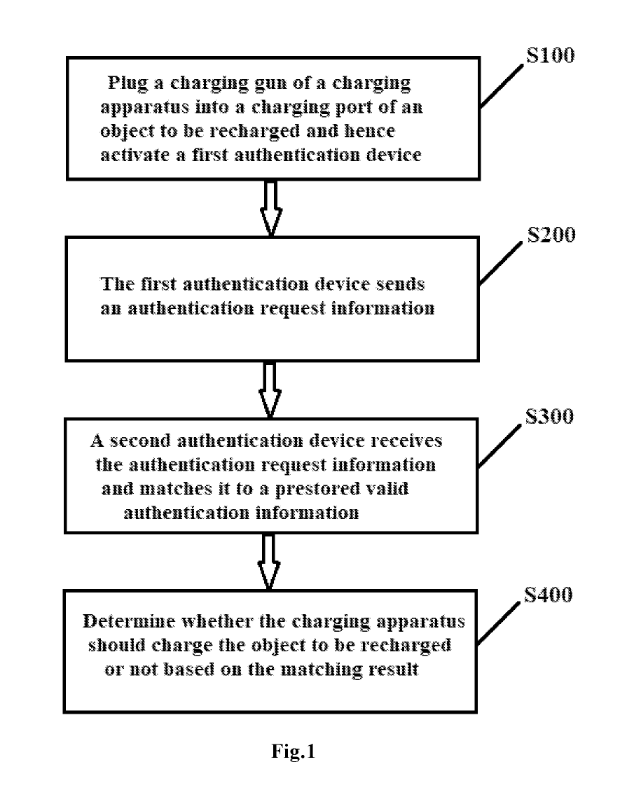

The automatic authorization approach for charging apparatuses of the application is described below in detail in conjunction with FIG. 1, using a charging post and an electric vehicle as examples.

As showed in FIG. 1, the automatic authorization approach for charging apparatuses of the application comprises: step S100, plugging a charging gun of a charging apparatus into a charging port of an object to be recharged and hence activating a first authentication device; step S200, the first authentication device sending an authentication request information; step S300, a second authentication device receiving the authentication request information and matching it to a prestored valid authentication information; step S400, determining whether a charging apparatus should charge the object to be recharged or not based on the matching result.

Particularly, in step S100, firstly drive the electric vehicle to a charging position, then take down the charging gun from the charging apparatus and plug it into the charging port of the electric vehicle. When the detection device on the electric vehicle detects that the charging gun is plugged into the charging port, the VCU (Vehicle Control Unit) of the electric vehicle may receive the signal sent by the detection device and activate the first authentication device. Certainly, the signal may also be sent directly to the first authentication device by the detection device and hence the first authentication device is activated, rather than via the VCU.

It may be understood by those skilled in the art that this detection device may preferably take the form of a circuit that is able to detect whether a charging gun is plugged into the charging port, wherein this circuit sends a signal indicating whether a charging gun is plugged into the charging port to the VCU by way of sending a voltage signal. Certainly, this detection device may also be any sensor that may detect whether a charging gun is plugged into the charging port, such as a proximity switch, a pressure sensor, a mechanical switch, etc. The changes in the particular form of the detection device should not place any limitation on the scope of protection of the application.

Further, an additional detection device may also be disposed on the charging apparatus, for activating the second authentication device when the charging gun is pulled out of the charging apparatus. In this way, the second authentication device may stay in a sleeping status under regular circumstances, and be activated only when the charging gun is pulled out of the charging apparatus, so as to save the standby power consumption of the second authentication device. It may be understood by those skilled in the art that this additional detection device may also be any sensor that is able to detect the charging gun has been pulled out of the charging apparatus, such as a voltage detection circuit, a proximity switch, a pressure sensor, a mechanical switch, etc. Preferably, the second authentication device is an authentication reception device, for receiving an authentication request information sent by an authentication transmission device. Certainly, those skilled in the art may enable the authentication reception device to consistently stay in an activated state as needed. More preferably, in the case that the charging gun is pulled out of the charging apparatus and the second authentication device is activated, the second authentication device may send a signal to the VCU of the electric vehicle or to the first authentication device and hence activate the first authentication device, and then an authentication request information is sent by the first authentication device (as described hereinafter in combination with step S200).

Particularly, in step S200, the first authentication device activated by the VCU of the electric vehicle sends out an authentication request information.

Then in step S300, the activated second authentication device matches the received authentication request information to a prestored valid authentication information. It should be understood by those skilled in the art that the authentication method between the electric vehicle and the charging post (i.e. the matching method between the authentication request information and the prestored valid authentication information) may be a method of password validation, or may be a method of validating whether a digital signature is correct using certificate authorization. Furthermore, a vehicle identification number (VIN code) of the electric vehicle, an engine serial number (an electromotor serial number), a battery serial number, a specific identification code preset and stored in the electric vehicle, or other serial numbers that may recognize the identification of the electric vehicle may be included, but not limited to those mentioned above, in this valid authentication information and the authentication request information. Because authentication is a technical means that is well known and commonly used by those skilled in the art, detailed explanations thereof are not given herein. Furthermore, said valid authentication information may be stored in the second authentication device, and/or in other positions that is able to be accessed by the second authentication device as well, such as in a backend server. This should not place any limitation on the scope of protection of the application.

In the step S200 and the step S300, the communication between the first authentication device and the second authentication device (authentication request information) may be implemented by way of short range wireless communication or wired communication. Particularly, the way of wireless communication may be a way of WIFI, Bluetooth, or ZIGBEE; the way of wired communication may be a way of Power Line Carrier (PLC) Communication, or may be a way of direct communication with data cable, i.e., establishing a first communication terminal and a second communication terminal which may be matched to connect with each other on the charging port of the electric vehicle and the charging gun respectively, where the first communication terminal connects with the first authentication device via a data cable, and the second communication terminal connects with the second authentication device via a data cable.

Finally, in step S400, determining whether the charging port should charge the electric vehicle or not based on the matching result in step S300.

More particularly, when the authentication request information received by the second authentication device is matched with a prestored valid authentication information, the charging port charges the electric vehicle; when the authentication request information received by the second authentication device is not matched with a prestored valid authentication information, the charging port is not allowed to charge this electric vehicle.

It should be understood by those skilled in the art that in order to guarantee that the second authentication device is able to accurately receive the authentication request information sent by the first authentication device, especially in the way of wireless communication, the first authentication device may be enabled to send the authentication request information to the second authentication device multiple times (such as 3 times), and when the second authentication device receives one of the authentication request information, the authentication request information may be validated and matched. Or, those skilled in the art may set a fixed communication time (e.g. 1 minute) as needed, during which the first authentication device continuously sends the authentication request information to the second authentication device, so as to guarantee that the second authentication device is able to receive the authentication request information during the set communication time. Further, when the second authentication device fails to receive the authentication request information during the set communication time, the authentication is determined to be failed, and the charging post does not provide a charging service to the electric vehicle. Even further still, when the authentication is failed, the charging post may warn the user that the authentication is failed via an indicating light or a sound, or the charging post may push the information to an APP of the charging post user's cell phone or to a backend server, to inform of the authentication failure and record the information of this authentication failure.

With the automatic authorization approach for charging apparatuses of the application, a user only needs to plug the charging gun into the charging port of the electric vehicle, the whole process of authentication is automatically accomplished by the electric vehicle and the charging post, effectively simplifying the procedures for a user to charge the electric vehicle using a charging apparatus. Also, the automatic authorization approach for charging apparatuses of the application is relatively more safe and reliable than a traditional authorization approach for charging apparatuses, which effectively avoid the problems, for example a RFID card is easy to be copied, a key of a physical lock is likely to be lost or illegally opened, a password of an APP is easy to be stolen, etc. and avoid the phenomenon that an electric vehicle is not able to be charged, which is caused by an authentication certificate (RFID card, cell phone, etc.) being lost or forgotten to be carried, etc.

Besides, when the first authentication device is disposed in a smart key of the electric vehicle, it is only required to plug the charging gun into the charging port of the electric vehicle and hence activate the second authentication device on the charging post, search for the smart key nearby, and when the smart key found is matched with the charging post, the charging post starts to charge the electric vehicle. If it fails to find a smart key or the smart key found is not matched successfully, then the charging post is not able to charge the electric vehicle.

Hereto the technical scheme of the present application has been described in combination with the preferred embodiments showed in the accompanying drawings, however, it should be readily understood by those skilled in the art that the scope of protection of the application is apparently not limited to these particular embodiments. Equivalent modifications or alternations may be made by those skilled in the art without departing from the principle of the application, and the technical scheme after these modifications or alternations will fall within the scope of protection of the application.

What is claimed is:

1. An automatic authorization method for charging apparatuses, comprising the following steps:
plugging a charging gun of said charging apparatus into a charging port of an object to be recharged and hence activating a first authentication device;
the first authentication device sending an authentication request information;
a second authentication device receiving said authentication request information and matching it to a prestored valid authentication information; and
determining whether said charging apparatus should charge said object to be recharged or not based on the matching result;

2. The automatic authorization method for charging apparatuses of claim 1, wherein the step of said “activating a first authentication device” further comprises:
activating said first authentication device, when a detection device disposed on said object to be recharged detects that a charging gun of said charging apparatus is plugged into a charging port of said object to be recharged.

3. The automatic authorization method for charging apparatuses of claim 2, wherein said first authentication device is disposed on said object to be recharged, or is used together with said object to be recharged.

4. The automatic authorization method for charging apparatuses of claim 3, wherein the step of “said first authentication device sending an authentication request information” further comprises: said first authentication device sending said authentication request information by way of wireless communication or wired communication.

5. The automatic authorization method for charging apparatuses of claim 4, wherein said wireless communication comprises WIFI, Bluetooth, or ZIGBEE.

6. The automatic authorization method for charging apparatuses of claim 4, wherein said wired communication comprises power line carrier communication.

7. The automatic authorization method for charging apparatuses of claim 5, wherein said second authentication device is disposed on said charging apparatus or on a remote terminal.

8. The automatic authorization method for charging apparatuses of claim 7, wherein the step of said “determining whether said charging apparatus should charge said object to be recharged or not based on the matching result” further comprises:
said charging apparatus is enabled to charge said object to be recharged, when said authentication request information is matched with a prestored valid authentication information; and
said charging apparatus is not allowed to charge said object to be recharged, when said authentication request information is not matched with a prestored valid authentication information.

9. The automatic authorization method for charging apparatuses of claim 1, wherein said charging apparatus is a direct current charging post, a direct current charger, an alternating current charging post, or an alternating current charger.

10. The automatic authorization method for charging apparatuses of claim 9, wherein said object to be recharged is an electrical apparatus.

11. The automatic authorization method for charging apparatuses of claim 10, wherein said electrical apparatus is an electric vehicle, or an electric motorcycle, or an electric bicycle.

12. The automatic authorization method for charging apparatuses of claim 9, wherein said detection device is a voltage detection circuit.

13. An automatic authorization system for charging apparatuses, comprising:
a first authentication device, which is activated when a charging gun of said charging apparatus is plugged into a charging port of an object to be recharged, and sends an authentication request information; and
a second authentication device, which receives said authentication request information and matches it to a prestored valid authentication information;
wherein said automatic authorization system for charging apparatuses is also capable of determining whether said charging apparatus should charge said object to be recharged or not based on the matching result above.

14. The automatic authorization system for charging apparatuses of claim 13, wherein said automatic authorization system for charging apparatuses further comprises a detection device, which is disposed on said object to be recharged, for detecting whether a charging gun of said charging apparatus is plugged into a charging port of said object to be recharged.

15. The automatic authorization system for charging apparatuses of claim 14, wherein said first authentication device is disposed on said object to be recharged, or is used together with said object to be recharged.

16. The automatic authorization system for charging apparatuses of claim 15, wherein said first authentication device sends said authentication request information by way of wireless communication or wired communication.

17. The automatic authorization system for charging apparatuses of claim 16, wherein said wireless communication comprises WIFI, Bluetooth, or ZIGBEE.

18. The automatic authorization system for charging apparatuses of claim 16, wherein said wired communication comprises power line carrier communication.

19. The automatic authorization system for charging apparatuses of claim 18, wherein said second authentication device is disposed on said charging apparatus or on a remote terminal.

20. The automatic authorization system for charging apparatuses of claim 19, wherein said automatic authorization system for charging apparatuses enables said charging apparatus to charge said object to be recharged, when said authentication request information is matched with the valid authentication information; and wherein said automatic authorization system for charging apparatuses does not allow said charging apparatus to charge said object to be recharged, when said authentication request information is not matched with the valid authentication information.

21. The automatic authorization system for charging apparatuses of claim 14, wherein said charging apparatus is a direct current charging post, a direct current charger, an alternating current charging post, or an alternating current charger.

22. The automatic authorization system for charging apparatuses of claim 21, wherein said object to be recharged is an electrical apparatus.

23. The automatic authorization system for charging apparatuses of claim 22, wherein said electrical apparatus is an electric vehicle, or an electric motorcycle, or an electric bicycle.

24. The automatic authorization system for charging apparatuses of claim 21, wherein said detection device is a voltage detection circuit.

25. An automatic authorization method for charging apparatuses, comprising the following steps:
receiving an authentication request information and matching said authentication request information to a prestored valid authentication information, when a charging gun of said charging apparatus is plugged into a charging port, or when said charging gun is pulled out of said charging apparatus; and
determining whether said charging apparatus should to provide a charging service or not based on the matching result.

26. The automatic authorization method for charging apparatuses of claim 25, wherein the step of “receiving said authentication request information” further comprises:
receiving said authentication request information via an authentication device by way of wireless communication or wired communication.

27. The automatic authorization method for charging apparatuses of claim 26, wherein said wireless communication comprises WIFI, Bluetooth, or ZIGBEE.

28. The automatic authorization method for charging apparatuses of claim 26, wherein said wired communication comprises power line carrier communication.

29. The automatic authorization method for charging apparatuses of claim 27, wherein said authentication device is disposed on said charging apparatus or on a remote terminal.

30. The automatic authorization method for charging apparatuses of claim 29, wherein the step of said “determining whether said charging apparatus should provide a charging service or not based on the matching result” further comprises:
said charging apparatus is enabled to provide a charging service, when said authentication request information is matched with a prestored valid authentication information; and
said charging apparatus is not allowed to provide a charging service, when said authentication request is not matched with a prestored valid authentication information.

31. The automatic authorization method for charging apparatuses of claim 27, wherein said charging apparatus is a direct current charging post, a direct current charger, an alternating current charging post, or an alternating current charger.

32. A charging authorization method for objects to be recharged, comprising:
detecting an action of requiring charging for an object to be recharged;
the object to be recharged sending an authentication request information; and
said object to be recharged accepting charging in the case that an authentication is granted.

33. The charging authorization method for objects to be recharged of claim 32, wherein said “detecting an action of requiring charging for an object to be recharged” further comprises: a charging gun being plugged into a charging port of said object to be recharged is detected by a detection device disposed on said object to be recharged.

34. The charging authorization method for objects to be recharged of claim 32, wherein the step of said “the object to be recharged sends an authentication request information” further comprises: activating an authentication device, sending said authentication request information with said authentication device.

35. The charging authorization method for objects to be recharged of claim 34, wherein said authentication device is disposed on said object to be recharged, or is used together with said object to be recharged.

36. The charging authorization method for objects to be recharged of claim 35, wherein the step of “sending said authentication request information with said authentication device” further comprises: said authentication device sends said authentication request information by way of wireless communication or wired communication.

37. The charging authorization method for objects to be recharged of claim 36, wherein said wireless communication comprises WIFI, Bluetooth, or ZIGBEE.

38. The charging authorization method for objects to be recharged of claim 36, wherein said wired communication comprises power line carrier communication.

39. The charging authorization method for objects to be recharged of claim 35, wherein said object to be recharged is an electrical apparatus.

40. The charging authorization method for objects to be recharged of claim 39, wherein said electrical apparatus is an electric vehicle, or an electric motorcycle, or an electric bicycle.

41. The charging authorization method for objects to be recharged of claim 39, wherein said detection device is a voltage detection circuit.

42. An automatic authorization method for charging apparatus, comprising:
pulling a charging gun out of said charging apparatus and hence activating a first authenticating device;
said first authentication device sending an authentication request information;
a second authentication device receiving said authentication request information and matching it to a prestored valid authentication information; and
determining whether said charging apparatus should charge said object to be recharged or not based on the matching result.

43. The automatic authorization method for charging apparatus of claim 42, wherein the step of said “activating a first authentication device” further comprises:
activating said second authentication device when a detection device disposed on said charging apparatus detects that said charging gun is pulled out of said charging apparatus; and
said second authentication device activating said first authentication device.

44. The automatic authorization method for charging apparatus of claim 43, wherein said first authentication device is disposed on said object to be recharged, or is used together with said object to be recharged.

45. The automatic authorization method for charging apparatus of claim 44, wherein the step of “said first authentication device sending an authentication request information” further comprises: said first authentication device sending said authentication request information by way of wireless communication or wired communication.

46. The automatic authorization method for charging apparatus of claim 45, wherein said wireless communication comprises WIFI, Bluetooth, or ZIGBEE.

47. The automatic authorization method for charging apparatus of claim 45, wherein said wired communication comprises power pine carrier communication.

48. The automatic authorization method for charging apparatus of claim 47, wherein said second authentication device is disposed on said charging apparatus or on a remote terminal.

49. The automatic authorization method for charging apparatus of claim 48, wherein the step of said “determining whether said charging apparatus should charge said object to be recharged or not based on the matching result” further comprises:
said charging apparatus is enabled to charge said object to be recharged, when
said authentication request information is matched with a prestored valid authentication information;
said charging apparatus is not allowed to charge said object to be recharged, when said authentication request information is not matched with a prestored valid authentication information.

50. The automatic authorization method for charging apparatus of claim 47, wherein said charging apparatus is a direct current charging post, a direct current charger, an alternating current charging post, or an alternating current charger.

51. The automatic authorization method for charging apparatus of claim 50, wherein said object to be charged is an electrical apparatus.

52. The automatic authorization method for charging apparatus of claim 51, wherein said electrical apparatus is an electric vehicle, or an electric motorcycle, or an electric bicycle.

53. The automatic authorization method for charging apparatus of claim 50, wherein said detection device is a voltage detection circuit.

54. An automatic authorization system for charging apparatuses, comprising:
a first authentication device, which is activated when a charging gun is pulled out of said charging apparatus and sends an authentication request information; and
a second authentication device, which receives said authentication request information and matches it to a prestored valid authentication information;
wherein said automatic authorization system for charging apparatuses is also capable of determining whether said charging apparatus should charge said object to be recharged based on the above matching result.

55. The automatic authorization system for charging apparatuses of claim 54, wherein said automatic authorization system for charging apparatuses further comprises a detection device, which is disposed on said charging apparatus, for detecting whether said charging gun is pulled out of said charging apparatus.

56. The automatic authorization system for charging apparatuses of claim 55, wherein said first authentication device is disposed on said object to be recharged, or is used together with said object to be recharged.

57. The automatic authorization system for charging apparatuses of claim 56, wherein said first authentication device sends said authentication request information by way of wireless communication or wired communication.

58. The automatic authorization system for charging apparatuses of claim 57, wherein said wireless communication comprises WIFI, Bluetooth, or ZIGBEE.

59. The automatic authorization system for charging apparatuses of claim 57, wherein said wired communication comprises power line carrier communication.

60. The automatic authorization system for charging apparatuses of claim 58, wherein said second authentication device is disposed on said charging apparatus or on a remote terminal.

61. The automatic authorization system for charging apparatuses of claim 60, wherein said automatic authorization system for charging apparatuses enables said charging apparatus to charge said object to be recharged, when said authentication request information is matched with a prestored valid authentication information; and wherein said automatic authorization system for charging apparatuses does not allow said charging apparatus to charge said object to be recharged, when said authentication request information is not matched with a prestored valid authentication information.

62. The automatic authorization system for charging apparatuses of claim 60, wherein said charging apparatus is a direct current charging post, a direct current charger, an alternating current charging post, or an alternating current charger.

63. The automatic authorization system for charging apparatuses of claim 62, wherein, said object to be recharged is an electrical apparatus.

64. The automatic authorization system for charging apparatuses of claim 63, wherein said electrical apparatus is an electric vehicle, an electric motorcycle, or an electric bicycle.

65. The automatic authorization system for charging apparatuses of claim 62, wherein said detection device is a voltage detection circuit.
